(19) United States
(12) Patent Application Publication
(10) Pub. No.: US 2019/0233141 A1
(43) Pub. Date: Aug. 1, 2019

(54) METHOD OF FILLING A CONTAINER AND CONTAINER CAPABLE OF BEING FILLED

(71) Applicant: KRONES AG, Neutraubling (DE)

(72) Inventors: Ute John-Unterburger, Regensburg (DE); Rupert Meinzinger, Kirchroth (DE); Michael Neubauer, Uebersee (DE)

(21) Appl. No.: 16/383,409

(22) Filed: Apr. 12, 2019

Related U.S. Application Data
(62) Division of application No. 14/383,852, filed on Sep. 8, 2014.

(30) Foreign Application Priority Data
Mar. 6, 2012 (DE) 10 2012 101 868.5

(51) Int. Cl. B65B 3/10; B65D 1/02; B65B 47/08; B67C 3/24; B65B 3/04; B67C 3/02; B67C 3/06

(52) U.S. Cl. CPC B65B 3/10; B65D 1/0207; B65B 47/08; B67C 3/06; B65B 3/04; B67C 3/02; B65D 1/0292; B67C 3/24

(57) ABSTRACT

Provided is a method for filling a container with a liquid in which the container is filled via an opening of the container and an internal volume of the container increases during the filling process and the internal volume of the filled volume is at least twice the volume of the unfilled container. Also provided is a device for filling containers, and a container having an opening, a base region, and a main body integrally formed with the opening and the base region, the main body being bent by a specified bending angle around a specified circumferential folding edge of the main body in such a way that the opening of the container is arranged closer to the base region than the circumferential folding edge is, wherein the position of the folding edge relative to the base region of the container can be changed during an expansion of the container.

### CROSS REFERENCE TO RELATED APPLICATIONS

This application is a divisional of U.S. application Ser. No. 14/383,852, filed Sep. 8, 2014, which was filed as a 371 of PCT/EP2013/054419, filed Mar. 5, 2013, claiming priority to German Application 10 2012 101 868.5, filed Mar. 6, 2012.

### BACKGROUND OF THE INVENTION

The present invention relates to a method and an apparatus for the filling of containers as well as to a container which is capable of being filled with the method described. A multiplicity of apparatus and methods for the filling of containers are known from the prior art. It is customary in this case for the empty containers, for example plastics material containers, to be filled with a liquid, for example a beverage, during a movement along a conveying path. To this end, widely differing variants are known, for example a hot filling of beverages or even a filling of beverages with different components.

In addition, different apparatus and methods of removing liquids from containers are also known from the prior art. In this way, DE 10 2007 054 431 for example describes a method of removing liquids. The contents of the disclosure of this patent application are hereby also made the contents of the disclosure of the present application in its complete entirety.

Conventional filling methods for containers have in part the drawback that a large amount of atmospheric oxygen which can adversely affect certain types of beverages, even during the filling procedure, is present in the empty container. In addition, precautions have to be taken in conventional filling plants to remove a residual gas during the filling.

The object of the present invention is to make the filling of containers simpler in these respects.

### SUMMARY OF THE INVENTION

In the case of a method of filling a container with a liquid the container is filled by way of an aperture of the container and an internal volume of the container is enlarged during the filling. In this case the internal volume of the subsequently filled container amounts to at least twice (preferably at least three times, preferably at least five times and in a particularly preferred manner at least ten times) the volume of the non-filled container.

It is therefore proposed that the container itself should be enlarged in the course of the filling procedure. This enlargement, however, does not relate to the possible slight increase occurring, which occurs as a result of the filling material poured in. It is proposed, rather, that a substantial increase in the volume of the container should occur, in particular just as a result of the filling procedure. The container is thus as it were “blow moulded” directly by the filling material to be poured in.

In the case of a preferred method the container is or has been expanded by an expansion procedure before the filling procedure. It is preferable for a plastics material pre-form first to be expanded to form a plastics material container and then for the plastics material container produced in this way to be advantageously reduced again in its volume, in particular folded, and preferably only then expanded again by the filling procedure.

It is thus advantageous for no stretching or at least no substantial stretching of the wall of the and/or of the material of the plastics material container to take place during the filling procedure, but in particular only an unfolding. It is therefore preferable for the container which is to be filled (as well as the aperture thereof) already to have its final shape in at least one area of the container, for example in a base area. This expansion procedure can be carried out in this case immediately before the filling, but it would also be possible for the containers first to be reduced in their volume again after their production and then to be stored and/or conveyed to a filling means in this reduced state.

It is preferable for the container to be compressed after the expansion procedure. In this way, it is possible in particular for the container produced by the expansion procedure to be folded in such a way that the internal volume thereof is reduced. In the folded state it is preferable for a pre-set wall portion, and in particular a continuous wall portion, to be situated adjacent to a further pre-set wall portion, and in particular to a further continuous wall portion. It is advantageous for these wall portions to touch each other in a state of the containers—folded together—at least locally and preferably along a peripheral face.

It is thus possible for example for a container first to be produced with the aid of a blow moulding machine and for this container then to be rolled in or folded in respectively, in order to reduce the internal volume of this container as much as possible in this way.

It is advantageous for the container to be folded with respect to a defined folding edge. It is preferable for this to be a folding edge extending continuously with respect to the longitudinal direction of the container, and in a particularly preferred manner a folding edge extending at least locally, and in a particularly preferred manner completely, in a straight line.

It is advantageous for the container to be folded in such a way that the folded container can be inserted into a further container which is folded in a corresponding manner. In this way, it is possible for two or more containers to be inserted one into the other—in particular in a cylindrical region thereof.

It is preferable for the container to be rolled in during the course of the folding procedure. In this way, a container shape folded or rolled in respectively in such a way has two concentric external diameters which are preferably situated one above the other. In other words, the container shape which is rolled in has a concentric internal diameter or a further concentric internal diameter which is smaller than a smaller external diameter.

In the case of a further advantageous embodiment the wall of the container has a thickness which is between 0.1 and 0.8 mm, preferably between 0.2 and 0.6 mm and in a particularly preferred manner between 0.3 and 0.45 mm. In particular, the container is pressure-stable for carbonated beverages, such as beer or soft drinks, for example.

In the case of a further advantageous method the container is folded or rolled in respectively in such a way that a volume ratio between the plastics material pre-form and the container of reduced volume (which are inserted one into the other) is smaller than 1:2, preferably 1:1.5 and in a particularly preferred manner smaller than 1:1. It is advantageous in this case for a volume ratio between a plastics material pre-form and the container which is not rolled in to be 1:50 in the case of a 20-litre container.

It is preferable, in the case of the aforesaid compression or folding procedure, for a compression of the material also to take place, which is preferably permanent. It is preferable for this deformation still to be present even after the filling under pressure.

It is advantageous for the container to be deformed in a cold state and, in particular, without the action of heat. This can mean that for example the plastics material pre-forms are cooled after their shaping to form plastics material containers, before they are compressed or folded respectively. It may also be sufficient, however, for the shaped plastics material containers merely not to be heated further.

It is advantageous for two or more containers compressed in this way to be subsequently stacked one in the other. It is easily possible for the stacked containers to be conveyed in this state. Before these containers are filled, the containers can be separated again and subsequently filled, in particular with a liquid.

It is advantageous for at least one wall portion of the container arranged at a distance from the aperture of the container to have substantially the same wall thickness before the filling procedure as after the filling procedure.

It is advantageous, during the filling procedure, for the container not to be heated or to be heated only to a temperature which is below that temperature which is present for the expansion of plastics material pre-forms into plastics material containers. It is advantageous, during the filling, for the container to be kept below a temperature of 80° C., preferably below a temperature of 60° C. and in a particularly preferred manner below a temperature of 40° C.

It is advantageous for the container to be unfolded during the filling procedure. It is advantageous during the filling procedure for a wall portion of the container to be displaced with respect to a further wall portion of the container, in particular along a longitudinal direction of the container.

It is advantageous for the container to be a container which is capable of being folded, and in particular a plastics material container and in a particularly preferred manner a blow moulded plastics material container. The material of the container can also be a different material—in particular capable of being folded—such as for example a metal, in particular aluminium.

In principle, it is both possible for the container to be filled with the aperture upwards or even upside down. In this way, a filling procedure is proposed for a container in which the internal space thereof has been reduced, in particular beforehand. It is therefore preferable for the internal volume of the container to be reduced before the filling procedure. This reduction could be carried out in this case immediately before the filling procedure, but it is preferable for this reduction of the internal volume to take place at a substantially earlier point in time and, in this way, it would also be possible for the non-filled containers first to be transported, for example delivered to a bottler.

The aforesaid original reduction in volume affords substantial advantages as compared with the conventional filling method. On the one hand, the atmospheric oxygen is reduced by the small volume and it can be additionally improved by a one-off or repeated evacuation and flushing with gas. The evacuation known in the prior art in the case of glass bottles can also be carried out in this case by the supporting action of a plunger (described in greater detail below). In addition, it would be possible for the beginning of filling to take place in an evacuated container.

A further advantage is that no return gas conveying is necessary on account of the increase in volume during the filling. This in turn results in a simple valve design and optionally also a regulation of the flow rate controlled by the stroke. It would also be possible in this case for the filling pressure to be regulated by way of the stroke movement. In this way, it would also be possible for example on the one hand for the container to be expanded by the filling pressure, but on the other hand for the container to be enlarged—optionally in an assisted manner—by the apparatus itself with respect to the volume of the latter during the filling procedure and for the filling procedure to be facilitated in this way. A filling of the container upside down is likewise possible. This affords an advantage with respect to a special gentle treatment of the product for example.

It is advantageous for the container to be expanded by a filling pressure exerted during the filling. In this case the force which is required in order to shape out the container in a controlled manner is high, but it need not be generated in a special manner for this. The generation of the force can occur predominantly and preferably also exclusively from the filling pressure itself. A filling pressure of more than 2 bar, preferably of more than 5 bar and in a particularly preferred manner of more than 10 bar is advantageous.

In the case of a further advantageous embodiment a distance between a base area and the aperture of the container varies during the filling. In this way, it is possible for example for the container to be folded together in the starting stage in such a way that the aperture of the container is situated very close to the base. The internal volume of the container is also increased by a corresponding unfolding of the latter.

In the case of a further advantageous method the container has a folding edge extending continuously (in particular contrary to the longitudinal direction of the container). In the case of this design an inner wall of the container is advantageously situated opposite an outer wall of the container in a radially continuous manner. In this case it is advantageous for the outer wall of the container to be arranged in this region inside the inner wall. It is advantageous for a plane, which is at a right angle to the longitudinal direction of the container, to be formed by this folding edge.

It is advantageous for a distance between this inner wall and the outer wall to be at least locally <1 cm, at least locally preferably <0.5 cm and at least locally preferably <0.3 cm. It is particularly preferred for this aforesaid distance to be made continuous in the peripheral direction. In this case it is possible for this distance also to be further increased during the filling by the pressures which arise.

In the case of a further advantageous method, during the filling procedure the aperture of the container is moved away from the base area of the container at a pre-set speed at least for a time and at the same time the aforesaid folding edge is moved away from the base area at a speed which is half this speed. This means that it is advantageous for both the aperture area and the folding edge to be moved away from the base area but for these speeds to act in the ratio of 2:1.

In the case of a further advantageous embodiment a filling element is locked with respect to the aperture during the filling. In this way, it is possible to ensure that during the filling the filling element does not slip off the aperture on account of the filling pressure. It is advantageous for the filling element also to be sealed off with respect to the aperture.

It is advantageous for at least one portion of the container wall to be deformed during the filling procedure. It is advantageous for this to be a portion of the container which is situated below the aperture, and in a particularly preferred manner in a region of a shoulder of the container. It is advantageous for the folding edge to disappear during the filling procedure. It is advantageous during the filling procedure for an annular portion of the container to be bent at an angle which is greater than 20°, preferably greater than 40°, preferably greater than 60°, preferably greater than 90°, preferably greater than 120°, and preferably greater than 150°, with respect to a further annular portion of the container. It is preferable for the container in a folded state to form a second folding edge, in which case it is advantageous for this second folding edge likewise to be made continuous. It is advantageous for a distance between the first folding edge and the second folding edge to be reduced during the unfolding or expansion respectively of the container. It is advantageous for the second folding edge likewise to form a plane which is at a right angle to the longitudinal direction of the container. It is advantageous for the container in a folded state to have no further folds apart from these two folding edges.

The present invention further relates to an apparatus for the filling of containers capable of being expanded, this apparatus having a filling element through which a liquid is capable of being supplied to the container by way of the aperture thereof. In addition, the apparatus has a first holding device for holding a base area of the container as well as a second holding device for holding an aperture area of the container.

According to the invention the first holding device and the second holding device are movable with respect to each other in a longitudinal direction of the container and at least one holding device (preferably the second holding device which holds the aperture area of the container) has a cross-section which is smaller at least locally than an internal cross-section of the filled container. It is preferred for this holding device to be suitable for being introduced into a main body of the container. It is advantageous for a cross-section of this holding device also to be adapted to a cross-section of the container (but preferably somewhat smaller).

In this way, it is also proposed with respect to the apparatus that a filling apparatus should be made available which itself also carries out an expansion of the container at the same time. In an advantageous manner a filling pressure for the liquid to be removed can be made available by way of the filling element, this filling pressure also being sufficient to expand and, in particular, to unfold the container.

In the case of a further advantageous embodiment the apparatus has a sealing element which seals off a region between the aperture of the container and the filling element. It is advantageous in this case for this sealing to take place completely and, in a particularly preferred manner, over the entire periphery.

In the case of a further advantageous embodiment the sealing element is capable of being fastened to the aperture of the container. In this case this sealing element can be clipped onto and/or screwed to the aperture. It would also be possible, however, for the sealing element to project into the aperture.

The present invention further relates to a container which is capable of being filled with a liquid, this container having an aperture, a base area and a main body formed in one piece with the aperture and the base area. In this case the main body is bent in such a way by a pre-set bending angle around a pre-set continuous folding edge of the main body that the aperture of the container is situated closer to the base area than the continuous folding edge. According to the invention a relative position (and/or a distance) of the folding edge is capable of being changed with respect to the base area of the container during an expansion of the container. It is also advantageous for a relative position of the folding edge to be capable of being changed with respect to the aperture of the container during an expansion of the container.

In this way, a container capable of being folded is proposed in this case, which in particular is folded in such a way that the aperture area is situated close to the base area of the container. It is advantageous, in this way, for the main body itself to be folded together with at least one folding edge and preferably with precisely one folding edge. It is advantageous for the container to be a plastics material container. In addition, however, it would also be possible for another material capable of being folded to be used.

In the case of a preferred embodiment an outer surface of the main body is situated in a continuous manner at least locally opposite an inner surface of the main body—in particular in a radial direction of the container. In this way, a highly effective reduction in the internal volume is achieved in the folded state of the container.

It is preferable for the outer surfaces and the inner surface of the container to be at a distance from each other at least locally which is >0.2 cm. It is advantageous for this to be a continuous distance and, in a particularly preferred manner, also a distance in a radial direction of the container.

In the case of a further advantageous embodiment a wall thickness of the main body is substantially constant at least locally (and in a particularly preferred manner in the entire region of the main body). It is thus proposed in this case that a thin-walled region for example for folding the container should not be set against another region, but that a fold of a wall region with a substantially constant wall thickness is preferably made. It is advantageous for the aforesaid folding edge also to be capable of being displaced during an expansion procedure. What is proposed therefore is not a constant folding edge around which a folding procedure is carried out, but rather a displaceable folding region which also moves in the course of the expansion of the container.

In the case of a further advantageous embodiment the container has a cylindrical cross-section at least locally in the longitudinal direction thereof. In this case it is possible for this cylindrical cross-section of the container to vary in the longitudinal direction. In this way, it would be possible for example for the container to have three or more portions in the longitudinal direction which have different cross-sections in each case. In the case of a preferred embodiment it is possible for the aperture of the container to be adjoined by a first cylindrical portion, for the latter to be adjoined by a second cylindrical portion with a second cross-section or diameter respectively and for the latter to be adjoined in turn by a third portion with a third cylindrical cross-section or diameter respectively. In this case the second cross-section can be larger than the two other cross-sections. The first cross-section is preferably smaller than the third cross-section or diameter respectively.

In addition, it would also be possible for the container to have a sphere-like cross-section in a region adjoining the aperture.

It is advantageous for a region of the container to have arranged in it an identification element which is capable of being read out, in particular, without contact and by means of which at least one piece of information is capable of being read out which is characteristic of the container. It is preferable for this to be an RFID element such as, in particular but not exclusively, an RFID chip.

It is advantageous for the identification element to be connected in an inseparable manner to the container. It is advantageous for this information to be selected from a group of pieces of information which contains a best-before date, information about the type of beverage or the like.

In this way, it would be possible to ensure for example that containers, of which the best-before date is past, are no longer emptied. On the basis of the knowledge of the type of beverage it is possible for example for relevant parameters for the removal to be controlled, such as for example an appropriate pressure.

In the case of a preferred embodiment the identification element is arranged in the form of a label on the container. In addition, it would also be possible for the identification element to be incorporated in an area of the container, for example a wall area.

In addition, it is possible for the identification element to be already incorporated in the containers during the production of the latter. In this way, it would be possible—during a production process for the container, in particular during a blow moulding procedure—for the identification element to be already held ready in a region of a blow moulding machine for example inside a wall of a blow mould and—during the procedure of shaping a plastics material pre-form into the container—to be fixed to the wall of the container.

In this context a suitable apparatus for the emptying of containers, and in particular containers of the type described above, is also explained. In the case of an advantageous embodiment an apparatus of this type has a read-out device for reading out—in particular wirelessly—at least one identification element attached to the container. In particular, this can be an apparatus for reading out an RFID element arranged on the container. In this way, the container to be emptied can be identified in a manner free of doubt. In the case of a further advantageous embodiment the apparatus has a control device which controls a removal procedure also in a manner dependent upon a read-out result of the read-out device. In this way for example, the user can be informed by means of an alarm that he or she is using a container which is unsuitable for the removal procedure. In addition, a removal procedure can be interrupted or the start thereof prevented in reaction to a read-out result of this type.

It is also possible, if the control device establishes that a marking element is not provided on the container, for it to interrupt or not to initiate a removal procedure.

The present invention further relates to a plant for the filling of containers having a plurality of apparatus of the type described above. In this case a plant of this type also advantageously has a conveying device which conveys the containers along a pre-set conveying path, preferably at a right angle to the longitudinal direction thereof. The apparatus is advantageously designed in this case in such a way that it fills the containers during this conveying along the conveying path.

### BRIEF DESCRIPTION OF THE DRAWINGS

Further advantages and embodiments are evident from the accompanying drawings. In the drawings

FIG. 1 shows an apparatus according to the invention for the filling of containers in a non-filled state of the container;

FIG. 2 shows the apparatus from FIG. 1 in a partially filled state of the container;

FIG. 3 shows the apparatus from FIG. 1 in a completely filled state of the container;

FIG. 4 shows a further embodiment of an apparatus according to the invention for the filling of containers;

FIG. 5 shows a plurality of containers according to the invention;

FIG. 6 is a diagrammatic illustration of a plant for the filling, of containers;

FIGS. 7a, 7b are two illustrations for the rolling in or folding respectively of the container;

FIGS. 8a, 8b are two further illustrations for the rolling in of the container in a further embodiment;

FIG. 9 is an illustration to demonstrate the deformation of a shoulder area of the container;

FIG. 10 is an illustration of a roll-in procedure or folding procedure respectively for the container;

FIGS. 11a, 11b are two illustrations of a container before and after the folding;

FIGS. 12a, 12b are two further illustrations for a roll-in procedure or folding procedure respectively of a container;

FIGS. 13a, 13b show a further embodiment of a container according to the invention;

FIG. 14 shows a further embodiment of a container according to the invention;

FIG. 15 is an illustration of a rolled-in container;

FIG. 16 is an illustration of a base area of the container;

FIG. 17 is a further illustration of the base area of the container, and

FIG. 18 is an illustration of a plurality of containers inserted one in the other.

FIGS. 19a to g are illustrations of a container with identification elements.

### DETAILED DESCRIPTION OF THE INVENTION

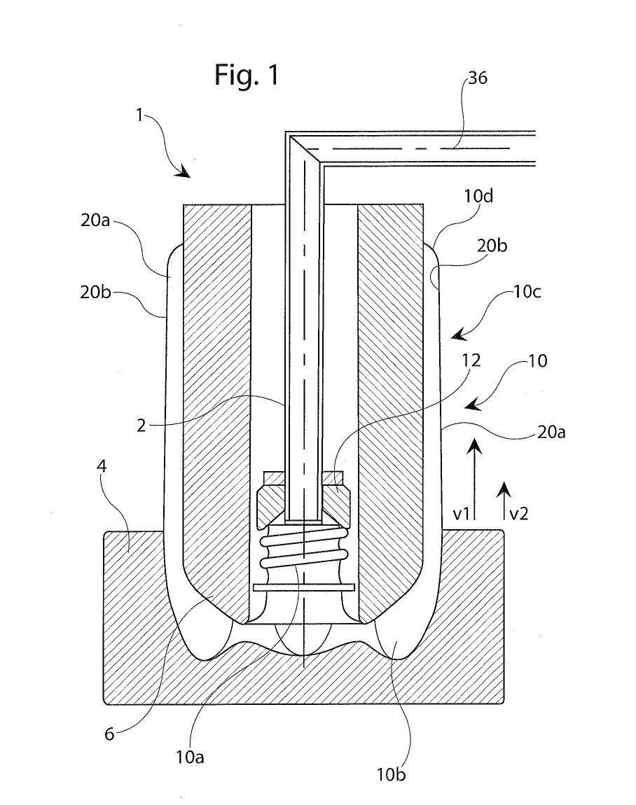

FIG. 1 is a partial illustration of an apparatus 1 according to the invention for the filling of containers 10.

The apparatus 1 shown in FIG. 1 has a first holding device 4 which in this case receives a base area 10b of the container to be filled. In the case of the embodiment shown in FIG. 1 this first holding device 4 is adapted with respect to its shape to the outline of the base area 10b in this case. In this way, it would also be possible for the holding device 4 to be arranged in an interchangeable manner on a carrier (not shown) in order to make the apparatus usable for different shapes of containers in this way.

The reference 10a refers to an aperture of the container 10, by way of which the container 10 is filled by a filling element 2 with a liquid, for example a beverage. The reference number 12 designates a fastening device by which the filling element 2 is arranged on the aperture 10a of the container 10 during the filling procedure. The reference 10c designates a main body of the container 10 which in this case is folded with respect to a folding edge 10d which, however, in the filled state of the container 10 is arranged between the base area 10b and the aperture 10a of the container 10.

The reference number 6 designates a second holding device which in this case receives the aperture region 10a of the container and which in the still non-filled state of the container is surrounded over its entire periphery—in this case by an outer wall 20a of the main body 10b—and engages in this outer wall 20a. A corresponding inner wall 20b of the container is situated opposite the outer wall 20a of the container 10 in this case and is arranged radially inside the outer wall 20a.

The fastening device 12 also acts as a sealing element, in order to seal off a region between the filling element 2 and the aperture of the container 10, so that no liquid runs laterally past the aperture of the container. It is advantageous for the holding device 6 to have a cavity in which the filling element 2 and preferably also a line attached to the filling element are arranged.

In the situation shown in FIG. 1 a container of reduced volume is pressed onto the first holding device 4 which in this case also acts as a supporting plunger, and the holding device or base cup respectively is situated in the base area 10b for abutment. In this position the container to be filled can also be evacuated, and in addition a stationary or dynamic flushing can also take place and the filling procedure can begin. In contrast to conventional methods, there is the advantage in this case that only a very small volume has to be evacuated or flushed respectively.

In the case of a dynamic flushing procedure it would also be possible for the second holding device 6 and/or the first holding device 4 to be altered in a dynamic or pulsating manner respectively (with respect to their relative position) and thus for the internal volume of the container also to be altered in a dynamic or pulsating manner. This change in the volume can also be used for cleaning the container or even for cleaning a filling system. The reference letter R designates a radial direction of the container 10.

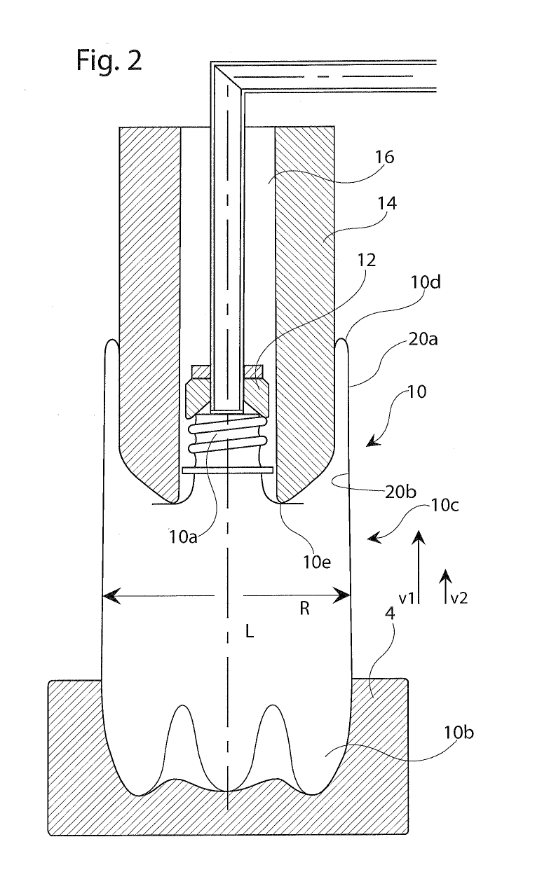

FIG. 2 is an illustration of the container shown in FIG. 1 during a filling procedure. In this way, a partially filled container 10 is shown in this case, in which a relative movement occurs between the first holding device 4 and the second holding device 6 or the supporting plunger respectively during the filling procedure. This movement takes place in this case in the direction v1 or v2 respectively also illustrated in FIG. 1. These directions are parallel in this case to the longitudinal direction L of the container. In addition, these references v1 and v2 also indicate the speeds at which the holding device 6 on the one hand and the folding edge 10d on the other hand move. The speed v1 at which the holding device 6 moves is at least for a time double the magnitude of the speed v2 at which the folding edge 10d moves.

In the case of the embodiment shown in FIG. 2 the second holding device is inserted into the container from the shoulder of the container and the first holding device supports the base. It is particularly preferred in this design for the second holding device 6 to be held stationary and for the first holding device 4 to move (in this case downwards). In this case the filling system itself can remain stationary and the design can be simplified. It would also be possible, however, for a movement of the second holding device 6 to be carried out and for the first holding device 4 to be arranged so as to be stationary. The reference number 14 refers to a plunger on which the holding device for holding the aperture area 10a of the container is also formed and which is capable of being inserted into the interior of the container. The reference number 16 designates a cavity which is formed inside this plunger and in which the filling element 2 and the filling line are also arranged in this case. This cavity can be designed in the manner of a bore.

In the case of a further design it would also be possible for the supporting plunger or the second holding device respectively to be drawn out from the base and for the shoulder of the container to be supported by a cup. In the case of this embodiment the bead or the folding edge 10d respectively would be directed downwards. If the folding edge or the bead respectively is directed downwards, then the folding edge is also filled with a product and, in this way, it would be possible for the container to be filled in a still better manner.

In addition, the container 10 also advantageously has a second folding edge 10e. This second folding edge 10e is advantageously arranged radially inside the first folding edge 10d and advantageously moves with the aperture 10a of the container during the unfolding of the container.

During the unfolding of the container 10 it is preferable for a bending of a first portion of the container relative to a second portion of the container also to take place with respect to this second folding edge 10e, preferably at an angle which is between 10° and 170°, preferably between 20° and 160°, preferably between 30° and 150°, preferably between 50° and 130°, and in particularly preferred manner between 70° and 110°. The second folding edge 10e advantageously faces in a direction opposed to the first folding edge 10d.

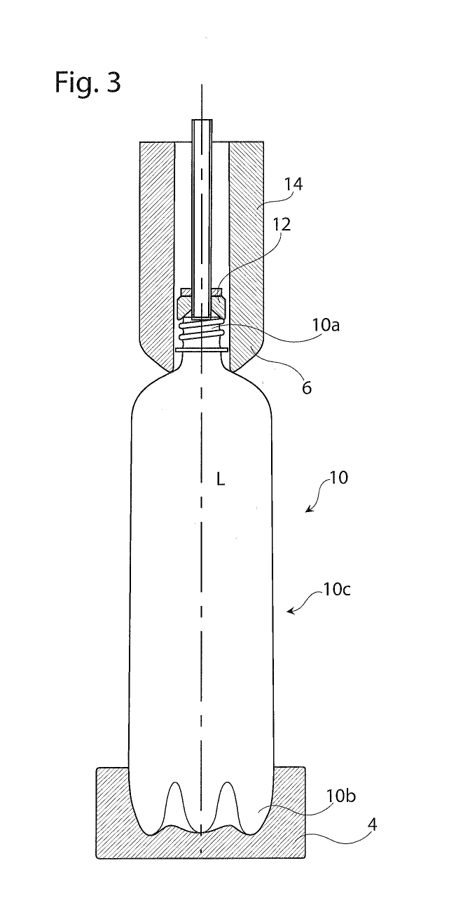

FIG. 3 shows a completely filled container in which the folding edge 10d or preferably the two folding edges 10d, 10e respectively has or have disappeared accordingly. In this case it is also possible for the filling quantity or even the filling level to be implemented by the completed stroke or even by way of separate measurement apparatus, such as flow meters, light barriers, level probe[s] and the like. A discharge of the container can be carried out in this case by way of a further stroke in which a filling valve has already closed. In addition, this discharge can also be carried out in this case during a movement of the container along the conveying path thereof, in this case for example in a horizontal direction.

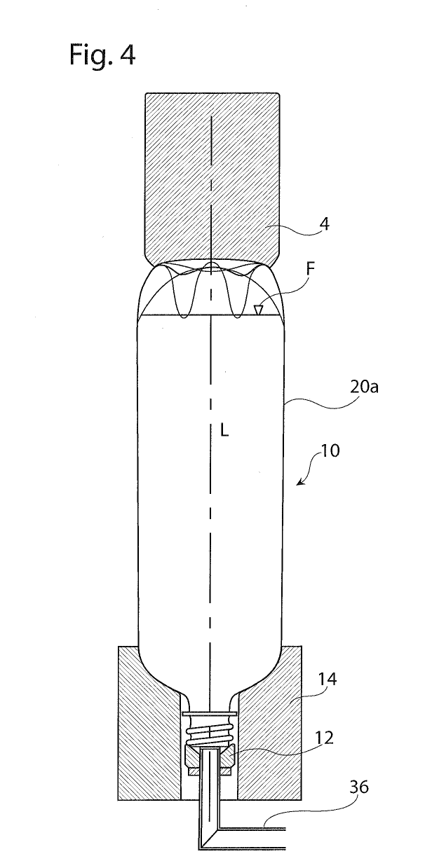

FIG. 4 shows a completely formed-out container which, however, has been filled in this case with the aperture thereof towards the bottom. The advantages in this embodiment lie in a different filling and in the possibility of emptying the container in a satisfactory manner after a liquid cleaning. In the case of the illustration reproduced in FIG. 4 the container has been formed out from the base. The plunger or the first holding device 4 respectively is on the side of the base in this case and the folding edge would also be formed upwards in this case. In this way, the first holding device could move upwards in an advantageous manner in the longitudinal direction L of the container 10 in this case. During the expansion of the container 10 the folding edge 10d thus also faces upwards in this case. After the filling, the container has to be rotated in a sealed-off manner in order to be processed further. In this position too, the container can be released from pressure by the stroke movement (the first holding device). To this end no gas need escape out of the container, which has also not been used in this way.

The beverage to be poured in can be for example beer or the like, which is poured into PET bottles, in order to achieve advantageous oxygen values. The size of the container is only of subordinate importance in this case. In this way, it is possible for containers ranging from those with volumes of less than half a litre to those with volumes of over 30 litres to be processed. On the other hand, even so-called soft drinks in which CO₂ is used or juices which are susceptible to oxygen can be filled in the manner proposed in this case. The reference letter F designates a filling level of the liquid inside the container.

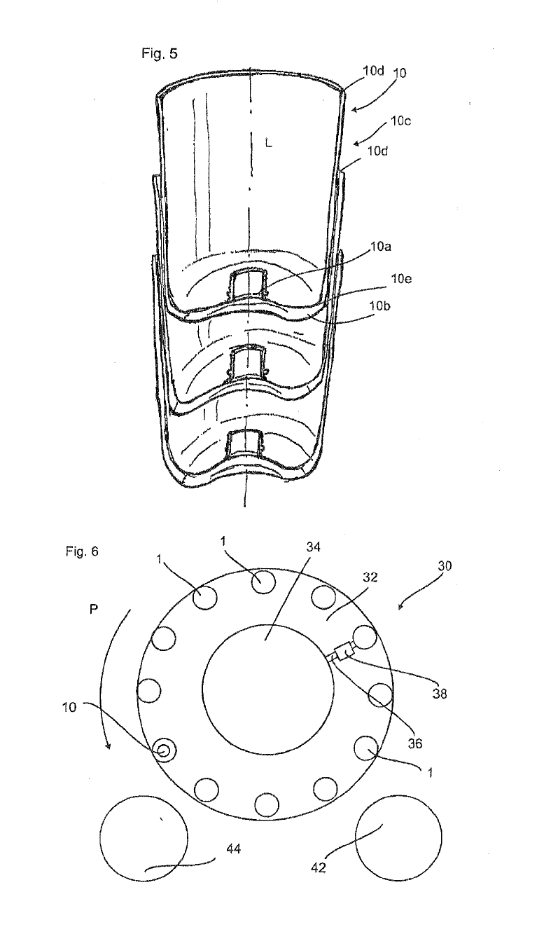

FIG. 5 is a further illustration of a plurality of containers 10 folded together. It is advantageous for a conventional container first to be produced, for example by means of a stretch blow moulding process. After that, this container is folded over so that it is present in the embodiment shown in FIG. 5. In the case of a suitable design of the main body 10c of the container the latter can be designed in such a way that a plurality of folded containers 10 can be stacked one in the other. This facilitates the conveying of containers of this type. The folding of containers of this type can likewise be carried out by two holding devices, between which the container is arranged and which are subsequently moved towards each other.

In this case it is possible for the container 10 to be acted upon with a medium, in particular a gaseous medium such as for example (sterile) air, during the folding together in order to assist the desired folding process with respect to the two folding edges. In addition, it would be possible for a closure, which allowed the escape of air from the container only in relatively small quantities, to be arranged on the container during the folding together, so that the container is under a certain internal pressure at least at first during its compression. As soon as the two folding edges 10d and 10e are formed it would also be possible for the container to be compressed further by the additional evacuation of air. In addition, it would be possible for an internal sterilization also to be carried out during a folding together of the container (for example by being acted upon with a sterilization agent such as hydrogen peroxide).

The reduction in volume of the container can be carried out both after the production of the container, for example in a spatially separate manner before the filling procedure in order to keep the conveying volume as small as possible in this way. This is suitable in particular for filling operations which themselves do not produce containers.

The reduction in volume can also, however, be carried out directly in the filling machine or even in a cleaning machine arranged upstream. In this case it would be possible for lifting cylinders which are required for pressing and sealing purposes likewise to be used.

As shown in FIG. 5, there is the possibility, for still more space-saving conveying or for storage, of designing the containers in such a way that they are capable of being stacked one in the other at reduced volume. In this way, a cross-section of the container could be enlarged for example starting from the base area of the container to for example the middle of the main body 10c and could preferably then be reduced again towards the aperture 10a, so that even in the state shown in FIG. 5 the cross-section is enlarged starting from the base area as far as the first folding edge 10d.

In addition, it would be possible, in order to form a multiple-way system, for the containers to be returned from a corresponding bar installation, which uses the reduction in volume for emptying the containers, for re-use again. In the case of this type of re-use, the small volume of the containers not only benefits the conveying but also allows a smaller demand for cleaning agent in order to clean the containers on the inside.

FIG. 6 shows a plant 30 for the filling of containers, which has a plurality of the apparatus 1 shown in FIG. 1 for the filling of containers. Furthermore, the plant can have a rotatable carrier 32 on which this plurality of the apparatus 1 shown in FIG. 1 are arranged. In addition, the entire apparatus can also have a reservoir 34, such as for example a filling boiler, which supplies the individual apparatus in this case with the filling material by way of a connecting line 36. This carrier 32, on which a plurality of the apparatus shown in FIG. 1 can be arranged, is advantageously made circular or in the form of a filling wheel respectively. The reference letter P designates the conveying path of the containers to be filled.

In addition, it is possible for an apparatus of this type for the filling of containers also to have measuring instruments 38 which allow a measurement of the quantity of the filling material poured into the container. In this way, for example, a flow meter can be provided which determines in a quantitative manner the filling material flowing by way of the line 36. In addition, weighing devices can also be provided which determine the weight of the container 10 in order to allow a measurement of the quantity in this way. The reference number 42 designates a supply device in order to supply the containers not yet filled and preferably also not yet folded to the plant, and the reference number 44 designates a removal device in order to remove the containers from the plant 30. The supply device 42 and/or the removal device 44 can be designed in this case in the form of conveying star wheels.

In addition, the plant 30 can also have arranged upstream of it a blow moulding machine (not shown) for producing the containers, as well as a device which folds over the containers 10 or folds them together respectively.

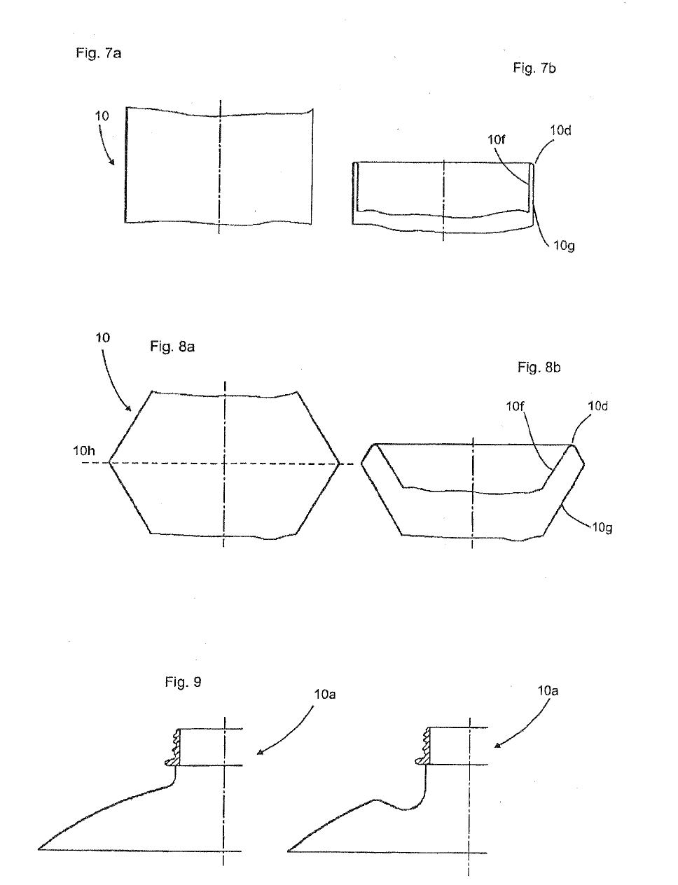

FIGS. 7a and 7b illustrate a process of folding over or rolling in a container 10. In this case it is possible for the container 10 to have a plurality of diameters coordinated with one another in different ways, in order to achieve the stacking function in a rolled-in or folded state. As shown in FIG. 7b, the wall of the container 10 has to be moved past itself. In order to achieve a crease-free mutual insertion of the container, it is necessary for the tool which is used for the rolling in or folding respectively to be adapted as precisely as possible to the diameter of the container in this case. Since—as shown in FIG. 7b—the wall of the container is moved past itself, the diameter either of the wall 10f now on the inside has to be reduced and/or the diameter of the outer wall 10g has to be increased. The Applicants have discovered that as a rule the diameter of the inner wall 10f is in fact compressed.

FIGS. 8a and 8b show a further possible embodiment of a container. In this case the container has a cylindrical wall which is first enlarged and then tapers inwardly again in the direction of a middle region 10h. In this case too, the folding over of the container is shown again in FIG. 8b. It will be noted that the upper portion of the container rests in a folded-in or rolled-in state against the lower region, since these are enlarged or taper inwardly respectively in the same way or at the same angle respectively in each case.

FIG. 9 illustrates the shaping in an aperture area 10a of the container 10. The right-hand portion of FIG. 9 shows the shaping in the shoulder area in this case. In particular, it would be possible in this case for the shoulder area to be designed in the manner of a sphere or in the shape of a sphere, in order to facilitate the shaping in this way, as shown in FIG. 9.

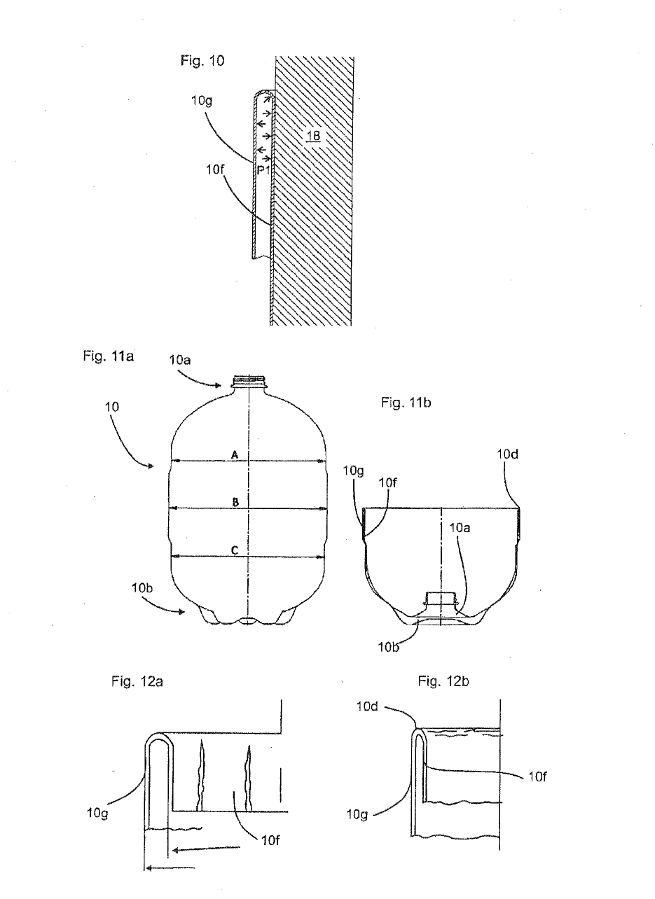

FIG. 10 is an illustration to demonstrate a shaping procedure or folding procedure respectively or a rolling-in procedure. In this case it is difficult per se to produce the two walls with a previous difference in diameter, since this point on the container wall has to be moved past itself. In order nevertheless to achieve a crease-free compression of the wall of the container, it is proposed that an internal pressure P1 should be applied to support the container wall to be compressed. This can be carried out for example by an escape of air being allowed only in a defined manner after the production of the container.

FIGS. 11a and 11b show an advantageous design of a container according to the invention. It will be noted that in this case three diameters A, B, C in different portions of the container 10 are provided. The purpose of these different diameters is not the rolling in, but the subsequent stacking ability. In this case it will be noted on closer consideration that the upper diameter A in the blow moulded original shape is greater than the lower diameter C, although they are rolled into each other in an opposed manner, i.e. the region with the diameter A present in this case is rolled into the region C. The Applicants have found that by such a choice, i.e. a larger diameter or a larger cross-section respectively, of that portion of the container which is rolled into another one, a substantially crease-free compression of the container can be achieved.

FIG. 11b shows a corresponding folded-in or rolled-in state of the container.

A compression of the container diameter is limited by the material properties as well as also by physical influencing factors, such as for example pressure, temperature and the wall thickness as well as the container diameter. If excessive deformation occurs in this case as a result of a compression process, the diameter can become so small that the wall buckles outwards. In the case of a diameter which is too large or a deformation which is too small respectively, the rolling radius is too small to ensure a proper or stress-free rolling in.

FIG. 12a shows a situation in which the differences in diameter are selected to be too large. In this case buckling points occur in the wall or the wall portion 10f respectively. In the illustration reproduced in FIG. 10b the rolling in can likewise become problematic on account of the small radius of curvature in the region of the folding edge 10d.

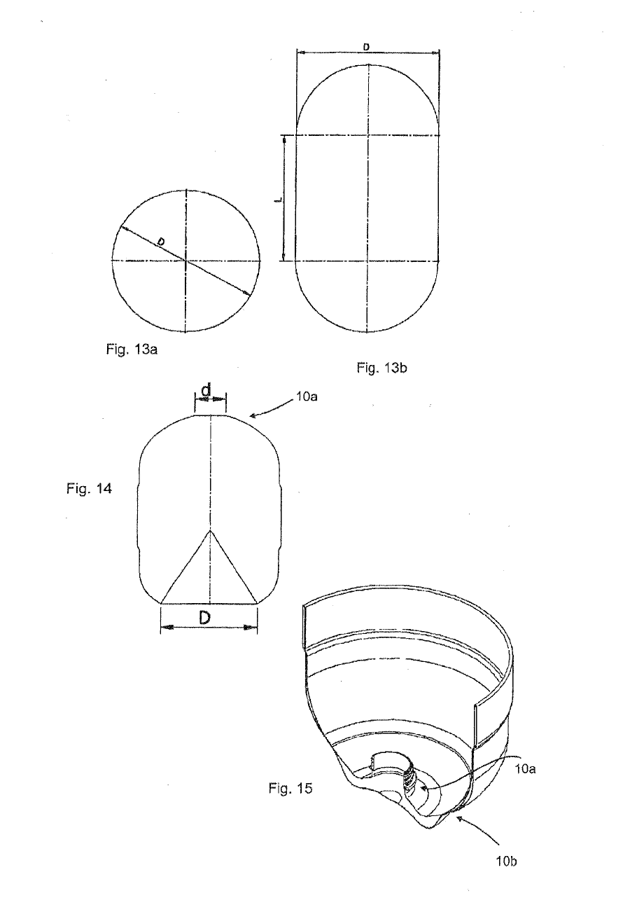

FIGS. 13a and 13b show a further design of the container. In this case the container has a spherical shape illustrated roughly in FIG. 13b in the aperture and base regions. A spherical shape of this type is advantageous for PET containers in order to achieve the maximum volume with the possibility of thin wall thicknesses or a high degree of pressure stability respectively. Since the diameter D of the container is limited (for example on account of the force for emptying and the packaging mass), however, the spherical shape must or can respectively be lengthened, as shown in FIG. 13b. In this case a cylindrical portion or a portion extending in a straight line respectively is present between two spherical base and aperture areas.

FIG. 14 shows a further design of a container of this type. Since the height is also limited, an attempt can be made in this case to flatten a spherical shape at the ends, in this case downwards for example, with the use of as little material as possible. In this case a reinforcement is provided by the aperture and the base of the container. Since an aperture 10a (which preferably has a screw closure or a snap closure) is kept small (for small closures and little use of material in the aperture area) in contrast to the base area but the base area should be large (in order to ensure a secure standing area), different degrees of flattening, as shown in FIG. 14, can also be present.

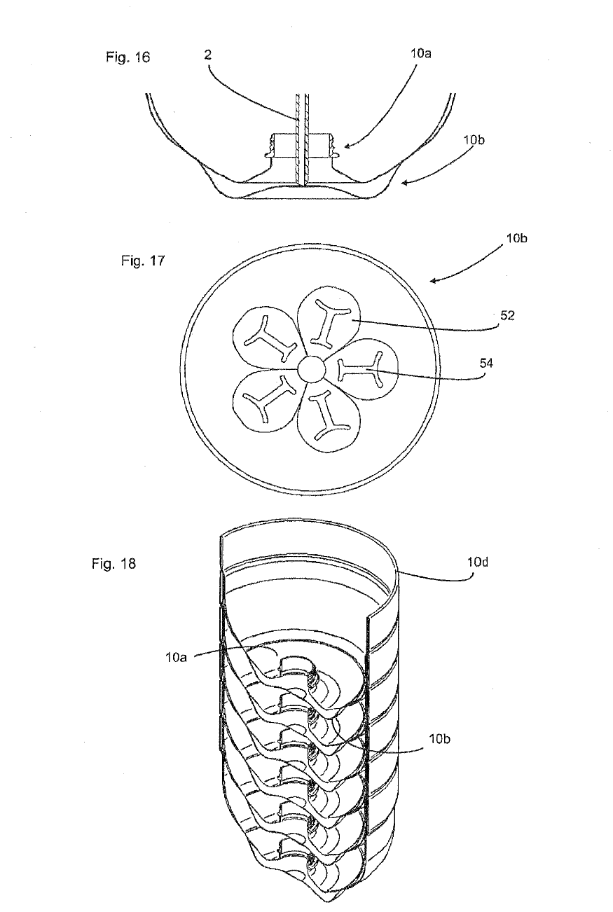

FIG. 15 shows a container in a folded-in or rolled-in state. It will be noted that the shaping of the base area 10b and the shoulder or the aperture area 10a respectively have a relationship so that they fit one into the other as well as possible during the rolling in.

FIG. 16 is a further illustration of a base area 10b. The base area 10b has to meet the demands of a high degree of stability in this case on the one hand, but it also has to allow a satisfactory emptying with a small residual quantity on the other hand. For this a deformation of the feet during the emptying procedure can also possibly be accepted.

FIG. 17 is a further illustration of a base area 10b. In this case it is possible for indentations 54 to be formed in the individual feet 52 of the base, in order to make it possible for the feet to be deformed in a defined manner during the folding together and, in particular, also during the emptying of the container.

It is advantageous for the container to be designed in such a way that it can be inserted into a container of similar design up to a minimum requirement which results from the aperture and the base shape. In order that this minimum stacking height may be achieved, the shoulder area is adapted to the base area to a considerable degree. In addition, it is also possible for the envelope diameter (this is the diameter beyond which the shoulder is deformed) to be selected in such a way that the aperture disappears far enough in the base area and foot space respectively.

FIG. 18 is a further illustration of a plurality of containers stacked one in the other. In this case it is possible for containers with or without a closure to be stacked. If the containers have a closure it is advantageous for a valve function to be incorporated in this closure so as not to have to dismantle the closure for filling purposes. In addition, it would also be possible, however, for a simplified conveying cap to be provided as a conveying protection and/or a protective cap.

Furthermore, it would also be possible for the container to have an UV protection by a suitable admixture of colours. It is advantageous for the container 10 to have an improved or special barrier property with respect to CO₂ permeation from the inside to the outside and/or of oxygen permeation from the outside to the inside. In this case the container can have additives such as for example so-called scavengers. A material with scavenger properties is a material which can intercept oxygen. In this case the material itself can have this property or, on the other hand, can contain substances which intercept oxygen. In this way for example, substances with scavenger properties can be added to the material of the container. In this case the scavenger for example intercepts in a seal the oxygen which is present in the head space of the filled and closed bottle. The use of a scavenger of this type for filling products sensitive to oxygen is particularly advantageous.

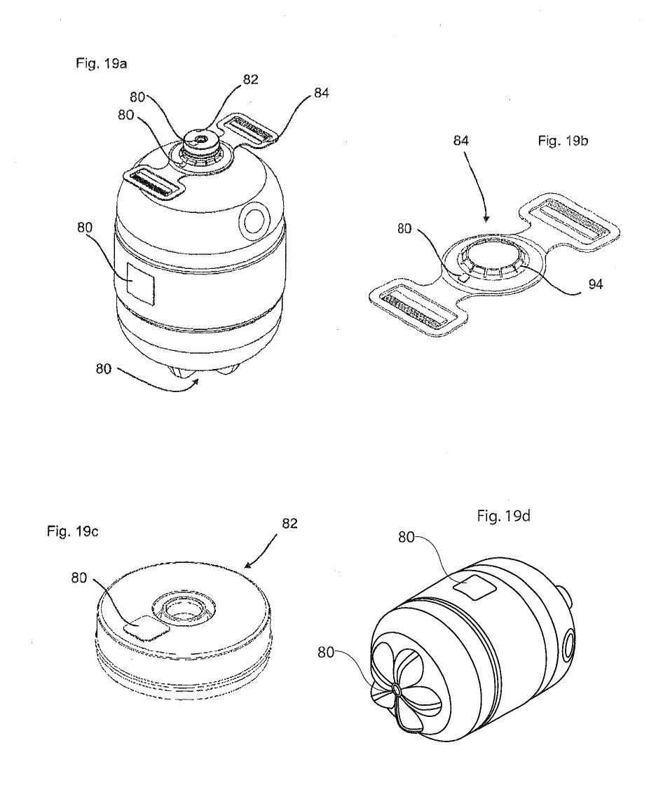

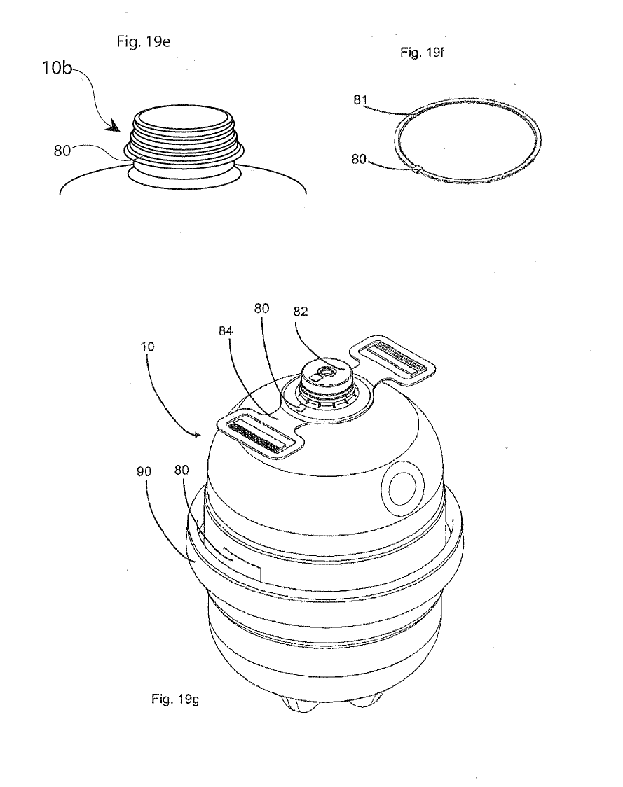

FIGS. 19a to g are a multiplicity of illustrations of containers with identification elements. In the illustration reproduced in FIG. 19a the regions are shown in which an identification element 80 of this type can be arranged. This can be situated for example on or in a closure 82 of the container, on a carrying handle 84 or on a wall area of the container 10 or a base area of the container 10. It would also be possible for a plurality of identification elements of this type, which are in particular RFID chips, to be provided.

FIG. 19b is an illustration in which the identification element 80 is arranged on a carrying handle. This holding handle 84 can be snapped onto the container by means of a snap-on means 94 by way of an aperture of the aforesaid container in this case. The identification element 80 can be incorporated or secured by adhesion for example in the carrying handle 84. The carrying handle 84 is advantageously arranged in a non-removable manner on the container by the snap-on means 94, as a result of which the identification element 80 is also fixed on the container in this way. Alternatively, the carrying handle is removable or is removable only with difficulty.

FIG. 19c is an illustration in which the identification element is arranged on a closure 82 of the container 10. In this case too, the identification element can be incorporated or even secured by adhesion for example in this closure.

FIG. 19d is an illustration in which the identification element 80 is arranged on a base or on a peripheral wall of the container. In this case too, the identification element can be inserted or incorporated. In particular, in the case of an arrangement on the wall, the identification element can also be incorporated in a label attached to the container. In these embodiments it is advantageous for the identification element to be arranged at a point on the container which is not situated in a region of the continuous folding edge during the removal process.

In addition to the use of RFID chips it would also be possible for other identification elements, such as in particular barcodes or QR codes, to be used. These could also for example be printed on a wall of the container.

FIG. 19e shows a further possible arrangement for an identification element 80. In this case the identification element is arranged on a carrying ring which is situated in an aperture area of the container 10. FIG. 9f is a more detailed illustration of this. In this case the identification element also has an aerial 81 which extends around the aperture 10b of the container 10 here.

FIG. 19g is an illustration to demonstrate the reading-out of an identification element 80. This identification element 80 is arranged in this case on a peripheral wall of the container. This apparatus for the removal of liquid has in this case an annular read-out device for reading out the identification element. This has the advantage that the container need not be arranged in the removal device in a correct rotational setting for the purpose of reading out. Conversely, on the other hand, it may also be desired for the identification element to be capable of being read out only in a precisely defined rotational setting. In this case the identification element can also be used to ensure an arrangement of the container in the removal apparatus in a correct rotational setting.

The Applicants reserve the right to claim all the features disclosed in the application documents as being essential to the invention, insofar as they are novel either individually or in combination as compared with the prior art.

### LIST OF REFERENCES

1 apparatus
2 filling element
4 first holding device
6 second holding device
10 container
10a aperture
10b base area
10c main body
10d folding edge
10e second folding edge
10f inner wall in the rolled-in state
10g outer wall in the rolled-in state
10h middle region
12 fastening device
14 plunger
16 cavity
20a outer wall
20b inner wall
30 plant
32 carrier
34 reservoir
36 connecting line
38 measuring instrument
42 supply device
44 removal device
80 identification element
81 aerial
82 closure
84 holding handle
90 read-out device
94 snap-on means
v1 direction of movement, speed
v2 direction of movement, speed
L longitudinal direction of the container
R radial direction
P conveying path
F filling level
A, B, C diameter
P1 pressure
D diameter

1. A method of filling a container with a volume of liquid, wherein the container is filled by way of an aperture of the container, comprising:
providing an unfilled pre-form container which is at least partially compressed and folded on itself so that the entirety of the aperture of the container lies radially inward and vertically between a folding edge and a base of the compressed pre-form container, whereby to reduce an internal volume of the container, whereupon the pre-form container is adapted to be stacked onto and partially within another unfilled at least partially compressed pre-form container; and
expanding the internal volume of the pre-form container by moving the aperture away from a base of the pre-form container while filling the expanding container with a volume of liquid, to form at least twice the volume of the unfilled pre-form container,
wherein
during the method the container is arranged in between a first holding device for holding a base area of the container as well as a second holding device for holding an aperture area of the container, and being held during the method by both holding devices, wherein
before filling, the empty container is stationary or dynamically flushed, in its pre-form state and wherein subsequently after flushing the filling procedure takes place, and further wherein
the second holding device is inserted into the container from the shoulder of the container and the first holding device supports the base so that the second holding device is held stationary and the first holding device is moved in this case downwards so that in this case a filling system itself remains stationary, and further wherein the apparatus is arranged on a rotatable carrier.

2. A method according to claim 1, wherein the entire apparatus has a reservoir, such as for example a filling boiler, which supplies the apparatus in this case with the filling material by way of a connecting line, wherein this carrier is made circular or in the form of a filling wheel respectively.

3. A method according to claim 1, wherein the container has been expanded by an expansion procedure before the filling procedure.

4. A method according to claim 1, wherein the container is expanded by a filling pressure during the filling.

5. A method according to claim 1, wherein a distance between a base area and the aperture of the container varies during the filling.

6. A method according to claim 1, wherein the container has a continuous folding edge.

7. A method according to claim 5, wherein during the filling procedure the aperture of the container is moved away from the base area of the container at a pre-set speed at least for a time and at the same time the folding edge is moved away from the base area at a speed (v1/2) which is half this speed (v1).

8. A method according to claim 1, wherein a filling element is locked with respect to the aperture during the filling.

9. A method according to claim 2, wherein a filling element is locked with respect to the aperture during the filling.

10. A method according to claim 3, wherein a filling element is locked with respect to the aperture during the filling.

11. A method according to claim 4, wherein a filling element is locked with respect to the aperture during the filling.

12. A method according to claim 5, wherein a filling element is locked with respect to the aperture during the filling.

13. A method according to claim 6, wherein a filling element is locked with respect to the aperture during the filling.

14. A method according to claim 7, wherein a filling element is locked with respect to the aperture during the filling.

15. A method according to claim 2, wherein the expanded container is compressed, and in particular folded, in such a way that the internal volume thereof is reduced.
